(19) United States
(12) Patent Application Publication
(10) Pub. No.: US 2002/0013904 A1
(43) Pub. Date: Jan. 31, 2002

(54) Remote authentication for secure system access and payment systems

(76) Inventor: Richard Mervyn Gardner, Chelwood Gate (GB)

Correspondence Address: RICHARD M. GARDNER, INNESWOOD, BEACONSFIELD ROAD, CHELWOOD GATE, E.SUSSEX, RH17 7LE, GB

(21) Appl. No.: 09/881,117

(22) Filed: Jun. 15, 2001

Related U.S. Application Data
(60) Provisional application No. 60/212,794, filed on Jun. 19, 2000.

(51) Int. Cl. H04L 9/00

(52) U.S. Cl. 713/184

(57) ABSTRACT

A method of authenticating users of controlled systems by providing for each registered user of the system to be required to produce an access code which varies for each user and for each occasion of use, by means of an account number, conventional fixed personal identification number and a random code grid matrix with embedded alphanumeric codes, in a preferred embodiment related to each weekday, date and month. The correct unique authentication code for any occasion for any registered user is known to a master computer system but may be produced by the registered user in a variety of ways, both online or in another interactive system and also directly from the code card without interactivity with the master system. The codes are randomly generated and therefore cannot be predicted as no pattern exists. Moreover, the order in which elements of the codes are required to be input is also randomly generated, during the authentication process itself for an interactive system, to produce secure remote authentication for any controlled system including online or network system access and especially payment card systems and transactions.

### CROSS-REFERENCE TO RELATED APPLICATIONS

This application is related to and claims priority from the U.S. Provisional Patent Application with the same title numbered 60/212,794 and with filing date Jun. 19, 2000

### FEDERALLY SPONSORED RESEARCH OR DEVELOPMENT

Not applicable

### REFERENCE TO A MICROFICHE APPENDIX

Not applicable

### BACKGROUND OF THE INVENTION

The present invention discloses a system and means of providing for access to protected systems, whether in the field of payment cards or remote banking transactions, computer or Internet access, internal computer system access, or indeed any enclosed system where identification of the particular person attempting entry has to be simple, effective and secure, by providing for an infinitely variable unique authentication code to be available for each customer on each occasion of use. As the context may require, the word “system” means either a range of linked elements (for example a central computer and linked personal computers) together making up one of the fields mentioned above, or those particular elements being described (for example an authentication system), and “Master System” is used to denote that central and controlling part of a system.

The level of importance attached to authentication will depend upon the consequences of unauthorised use, and this in turn will define the level of security required and consequential levels of cost and complexity.

Thus, the simplest and oldest form of controlling access would be a key (in a key and lock “system”). In modern systems, a token or device (all called a “device” hereafter) might be employed, capable of producing a fixed code readable by a machine or computer to grant or deny access. However, mere possession of such a device may allow access as such a system says nothing about who has that possession, and could not be called authentication.

As an improvement to such a system, a device might have a particular code that identifies who the user is (or at least whose device is being used) and may also be associated with a fixed Personal Identification Number (PIN) which has to be entered onto a device reader before the device communicated with a Master System.

To overcome problems associated with device authentication by means of fixed signals used on open networks, several systems have emerged which produce a variable Code which authenticates the device to the Master System.

U.S. Pat. Nos. 4,720,860 and 5,367,572 Weiss reveal variable authentication codes derived from a fixed PIN entry and a time or other variable algorithmic function. U.S. Pat. No. 5,056,141 Dyke discloses a means of matching variable word pairs contained both in a record (or device) kept by the user and in the Master System, such word-pairs having been pre-registered by the user. PCT Patent WO 91/09383 Watkins is similarly based upon pre-registered cue-responses. U.S. Pat. No. 5,163,097 Pegg discloses a variable PIN based upon selected algorithms which are known both to the user device and to the Master System, based upon a Fixed access number being altered by a variable cipher algorithm resulting in a different access key being used on each occasion. U.S. Pat. No. 5,355,413 Hisashi Ohno discloses a series of different numbers derived from an algorithm shared by the device and the Master System. U.S. Pat. No. 5,606,614 Brady et al discloses a system and means of providing for a series of stored passwords which are used in sequence by the user from a device recording such passwords, and lastly U.S. Pat. No. 5,627,355 Rahman et al discloses a unique series of personal numbers maintained sequentially in a Master System and a device

Whilst these systems clearly go some way towards solving the problem of authentication codes being used over insecure networks, or of preventing subsequent unauthorised use, none of them specifically authenticate the user, merely the device, even if the device is itself protected by a fixed PIN.

At a similar level, an Account number to identify a system user might be associated with a fixed PIN, without the necessity of any device, and this applies to many banking and network systems. It also applies to existing payment card systems, where the Payment Card Number is effectively the Account number (fairly readily known or intercepted) and other information (Expires date, name on card, Cardholder Verification Value etc.) is only available from the card itself and is similar to, though less secret than, a fixed PIN.

The security problems of existing payment card systems and fixed PIN's generally have been clear for some years and various systems have been devised to avoid their use and improve security. Thus, U.S. Pat. No. 5,239,583 Parrillo discloses a variable PIN where one at least of the digits of the access code vary for each of four occasions of use before repetition, based upon a four letter remembered fixed “password”. The relevant data from which the PIN's are selected are not remembered and are held on a sheet or card. There is also provision for an increased number of variables given additional Fixed passwords (four remembered four-letter passwords (equalling 16 letters in all) giving up to 10,000 variations). However the variations between sequential PIN's disclosed are again not great (one digit only) and the system is not random. U.S. Pat. No. 5,251,259 Mosley discloses a system of 7 varying access keys derived from a Code Grid sent to the user and corresponding with a grid in the Master System. The usable elements of the grid are based upon a fixed PIN which identifies which numbers are to be used for each day of the week. This system suffers from the same defects as Parrillo.

The general problem of payment card security for remote transactions has been addressed in other ways, those relevant to the present invention being concerned with proxy numbers i.e. payment card numbers which may be used either in limited circumstances or only once. U.S. Pat. No. 6,000,832 Franklin et al discloses a system intended to operate from a personal computer which generates a single use number using secret algorithms based upon specific personal and transaction data, but the authentication is really of the computer—as a device—and that of the user is based upon a fixed PIN, all giving the system limited cope. WO 0049586 Flitcroft et al discloses a system which is similar in outcome—controlled payment card numbers—but again authentication of the user is clearly based upon conventional means and does not form part of the Patent. WO 0129637 Enosh et al similarly discloses a unique transaction or payment card number for each transaction but again the authentication of the person using the system is not part of the disclosure and is therefore by conventional means.

Thus, various solutions to fixed PIN's and/or insecure networks have been attempted but hitherto these either produce a variable PIN by means of a device without authentication of the user except in turn by a fixed PIN, or can produce limited numbers of variable PIN's which are not of sufficient variation to constitute strong security or true user authentication.

### BRIEF SUMMARY OF THE INVENTION

The present invention provides a system and means for producing a Variable PIN (hereafter called a VPIN) which varies on each and every occasion of use. The numbers or letters from which the VPIN is derived are randomly generated (and not produced by any secret algorithm) and held in a matrix or grid available to the system user and from which the particular elements required on any occasion can be produced, either by the user, for direct use as authentication either of himself or a device, or by a computer Master System or by a device such as an Integrated Chip Card (a “Smartcard”) to produce a different VPIN each time.

In addition, the construction of the VPIN may also incorporate other elements including part of a fixed PIN in such a way that the input of a correct VPIN on any occasion of use simultaneously authenticates the specified authorised user and grants system access or authenticates a transaction.

### BRIEF DESCRIPTION OF THE SEVERAL VIEWS OF THE DRAWINGS

FIG. 1 is a flowchart showing the initial stages of customer/user registration to acceptance or rejection

FIG. 2 is a flowchart showing steps taken in the Master System subsequent to registration

FIG. 3 shows a VPIN Code card with numerical grid based upon the date and month

FIG. 4 shows a VPIN Code card with alphanumeric characters on a grid system for each Weekday W, Date D and Month M together with required elements of a Fixed PIN shown against each weekday with the specified order of input of required VPIN elements for a non interactive system

FIG. 5A is a flowchart showing the steps involved in a user accessing an interactive medium for authentication/access/payment card transaction up to connection with the User Interface

FIG. 5B is a flowchart continuing the steps involved in a user accessing an interactive medium for authentication/access/payment card transaction from connection with the User Interface to either rejection or authentication/system access/authorisation of a transaction as the case may be.

FIG. 6 is a flowchart showing the steps involved in using the VPIN system in a non-interactive environment from inception to either rejection or authentication/system access/authorisation of a transaction as the case may be.

### DETAILED DESCRIPTION OF THE INVENTION

The invention represents a system and method of achieving the aim of a fully variable PIN system (a VPIN and VPIN system) in relation to many different applications by a method of constructing a plurality of verification codes, a method of recording and inputting the correct code into a system and a method of receiving and validating or otherwise the input code and thereby determining whether or not, and if so at what level, access may be granted, or a payment transaction authorised, to an individual in respect of that input VPIN..

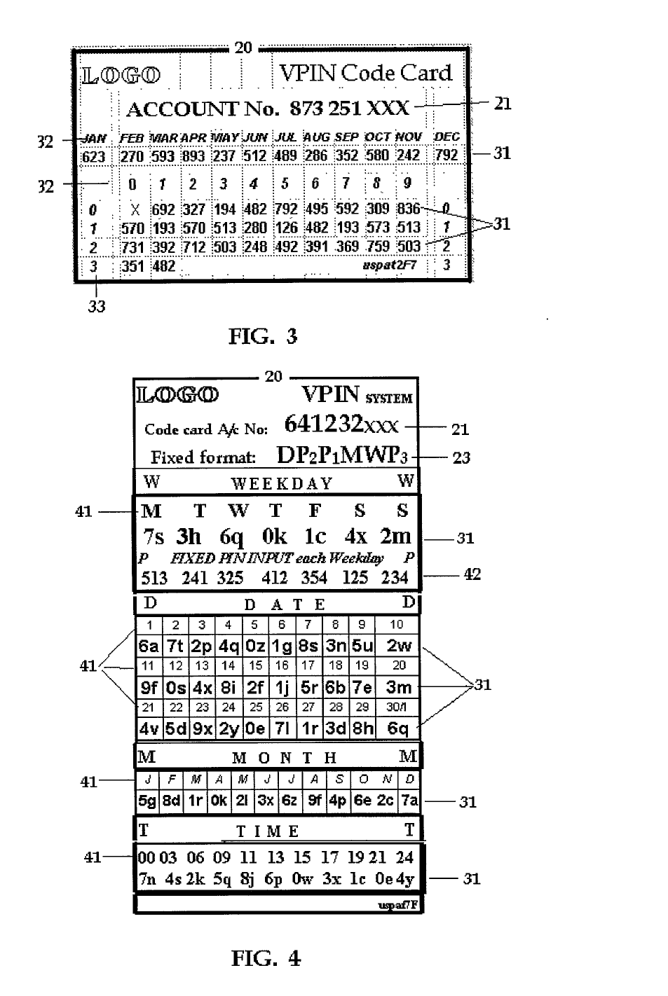

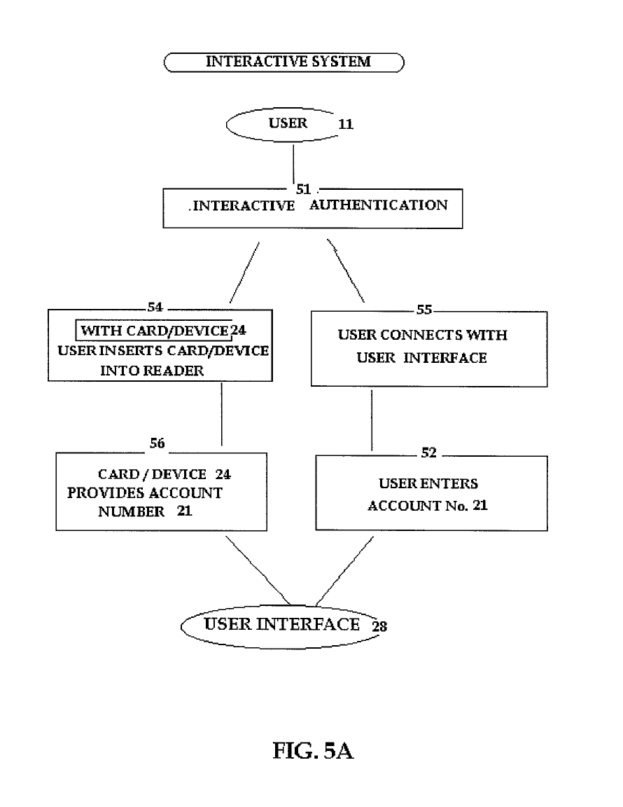

Thus, the invention provides for a system and means of enabling both a Master System and an authorised user of that system to independently produce, by way of authentication of the user and as the case may be of authorising a transaction or granting access, the required VPIN input code, which varies on each and every occasion of use, including several times in one day. This is achieved by the allocation by the Master System to each authorised user a VPIN Code Card with a series of numbers and letters set out in a grid as exemplified in FIG. 3 and FIG. 4, which would be sent to the authorised user subsequent to registration, either electronically or by post.

The VPIN Codes may consist of one or more tables of characters, whether digits or alphabetical, which are known to the Master System and to the user of the system, which coupled with grid references for identifying a particular character for use on a particular occasion, enables a user to use or input a VPIN which the Master System will recognise as correct on that, and only on that, occasion.

The characters set out in the VPIN Codes may be identified by a grid reference system with specific (e.g. Date or Month) labels, and there may also be a fixed PIN which is secret and of which some elements may form part of a required VPIN.

The use of digits is essential at present for most current systems based upon a telephone input or where interoperability with other systems is important, whereas an alphabetical or alphanumeric system could be used for a system based solely upon a computer system or the Internet.

The VPIN Codes containing the tables of digits may be prepared and recorded on the Master System in secure circumstances and sent to or communicated to the individual user of the system together with a fixed PIN, also prepared and notified in secure circumstances and both as practised in the industry for conventional PIN's.

The manner in which the VPIN Codes are stored by the Master System for verification purposes will vary with the system and method of input of a VPIN, but will typically involve on-line or other direct access for verification of an input VPIN to the Master System database, via a network system, the Internet, Website or by telephone.

The VPIN Codes may be recorded on one or more of a sheet of paper retained in secure circumstances at home or in an office, or recorded on a card perhaps of the size of a credit card on which the Codes are inscribed and which may be conveniently carried on the person, or they may be entered into a programme held on a computer at home or in an office in a secure fashion.

Where portability of the system access method is important, the VPIN Codes may additionally be recorded on a hand held device, or a Smartcard for use in connection with a reader attached to for example a personal computer, which would produce the required information to work out the VPIN i.e. it would indicate some of the digits and also indicate which parts of the remembered Fixed PIN were also required to produce the full valid VPIN.

By reference to the VPIN Code grids, digits from one or more of the Code tables can be indicated as part of the VPIN required for a particular validation, and these grid references may relate to such things as the Weekday, the Date, the Month, the Use number for that day, the Time of day to the last complete hour, or indeed any other method of precisely indicating which grid reference applies to a particular and specific use. Thus, a particular unique VPIN is derived from the system and may be input by the individual and recognised by the Master System as the single unique VPIN to give access to a particular person on that particular occasion.

The VPIN may be as short or as long as is consistent with ease of use in any given situation together with maintaining a level of security adequate for the risk involved in a security breach and the likelihood of the VPIN being overheard or intercepted. For example, in a situation such as a payment card or a cash withdrawal card, a maximum of four digits may be desired since this is consistent with industry practice and is the maximum likely to gain customer acceptance. However, for a system such as remote banking, for which an individual would normally be sitting at a home or office base with no special time pressure to properly ascertain the correct VPIN, a longer alphanumeric VPIN would be both desirable and acceptable. For a system where security need not be especially high, such as a user group for a remote or Internet service, perhaps a three digit VPIN would be sufficient.

An additional factor is whether or not the system is to be interactive: if it is, then differentiation between successive VPIN input attempts may be taken care of automatically by the Master System requiring a specific VPIN randomly generated from the known criteria. For example, the input required may consist of characters for the Weekday, Date and Month of input together with say 3 of a 5 digit fixed PIN, with successive inputs on a single day requiring different fixed PIN inputs and the characters for the W, D & M in a different randomly generated order (producing theoretically 720 different inputs for a single day).

It is a particular feature of the invention that the VPIN required on any particular occasion may be constructed without the need for interactivity i.e. both the Master System and the individual are able to work out separately the specific unique required VPIN for any occasion without collaboration (except for acceptance or rejection) and this may be achieved for example by providing for a particular specified order of the indicated characters for the Weekday, Date & Month plus the specified digits from the Fixed PIN indicated by the cumulative use number for that day which would then produce the required VPIN.

The VPIN, having been ascertained by reference to the VPIN Codes and the grid references, may be input by the individual by means of manual entry into a sales cash register or related hand held device, by manual entry into an Automatic Teller Machine (ATM), by manual entry onto a telephone keypad, or by manual entry into a computer keyboard. It could also be passed verbally over a telephone link, or used in a Mail Order transaction.

The system may require the input of a user name or account number so that the Master System can more easily ascertain whether or not the VPIN then entered is appropriate to the individual claiming access or authentication. In addition, the system may require the simultaneous use of a physical thing such as a magnetic stripe card or Smartcard being inserted into an ATM or a card reading device, possibly linked to a computer at home or in an office.

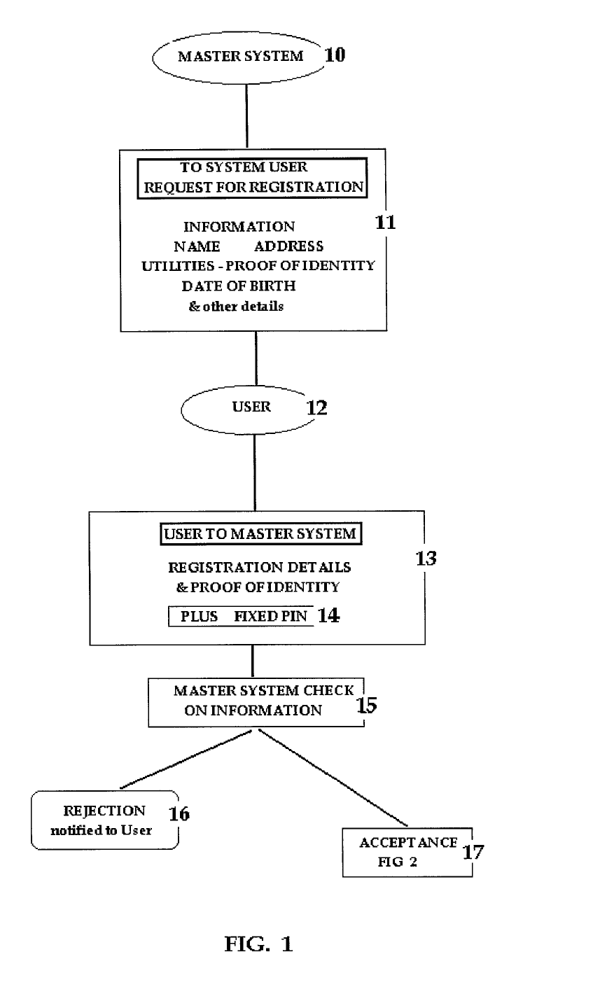

FIG. 1 shows in flowchart form the preliminary steps necessary to register a user 12 of the system. Thus the entity using the VPIN system would require computer facilities to deal with the various tasks involved, as summarised herein, and the term Master System 10 is used hereafter to represents this facility.

A user 12 would approach, or be approached by, the Master System 10 who would convey to the user details of the required information 11 either by post or online. This information request 11 would cover standard matters such as name and address, proof of identity, other personal details, all protected in a conventional manner by the Master System 10.

The user 12 would complete the information request 11 and send it 13 to the Master System 10, again by post or online. At least some of the information, such as proof of identity, would normally be sent physically by the user 12 except for a very low risk system.

In addition, for the preferred embodiment the user would identify a fixed 5 digit PIN 14 for use with the system and notify this to the Master System 10. Alternatively the Master System 10 would allot a fixed PIN 14 to the user 12 and leave the user 12 to change the fixed PIN 14 subsequently in a conventional secure manner as required.

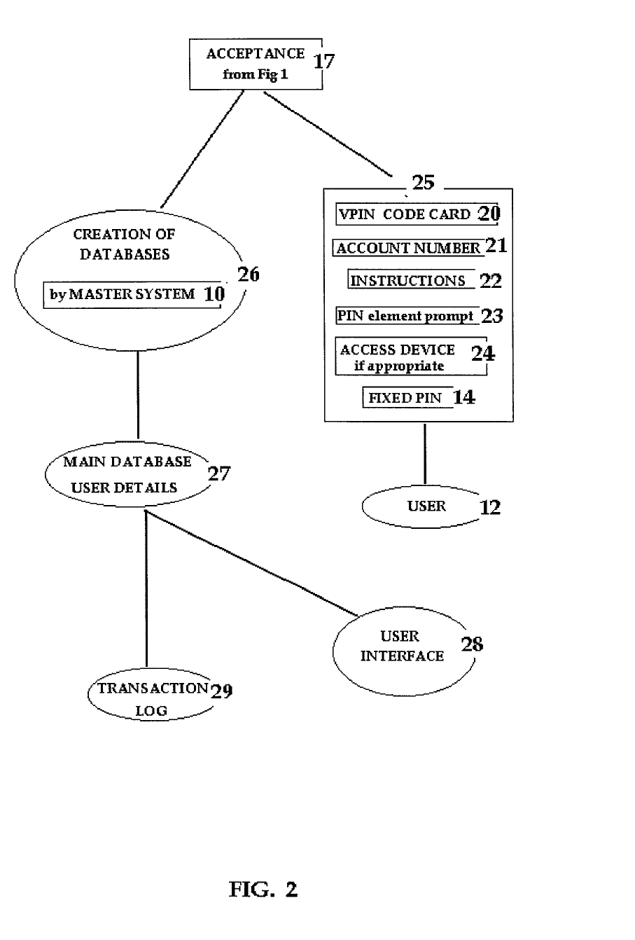

On receipt of the information 13 the Master System 10 would verify the details and reach a decision whether to reject the application 16 or to accept it 17, dealt with further in FIG. 2.

FIG. 2 is a flowchart of the steps taken after a potential VPIN system user has been accepted 17.

As part of the overall system set-up, the Master System 10 would have created three additional databases:

a Main Database 27 as an operational control from the Master System 10

a short term memory User Interface 28 which would be the interface between the Master System 10 and the user 12 and would contain operating instructions and system parameters

a Transaction Log database 29 which would record details of all transactions.

The Master System 10 would generate for each new user 12 the following:

a randomly generated user VPIN Code Card 20 as exemplified in FIGS. 3 and 4

a user Account number 21

a randomly generated PIN element prompt 23

The Master System 10 would send 25 to the user the Code Card 20 with Account number 21 and operating instructions 22, possibly contained additionally on a computer disc 24, and possibly with a device such as a Smartcard 24 with embodied details sufficient for the Smartcard 24 to generate a VPIN.

Details could remain indefinitely in the Transaction Log 29, or could after the time limits set by the Master System 10 be transferred from the Transaction Log 29 to the Main Database 27.

FIG. 3 shows a VPIN Code Card 20 with a randomly generated series of letters or digits 31 in a grid matrix layout whereby individual characters constituting VPIN elements are identified by reference to column headings 32 and row labels 33, by reference to a date and month. The VPIN Code Card 20 has an account number 21 which may be set out in full or may as illustrated have blank spaces relating to digits known only to the user 12 such as the users date of birth, so that use of the system by an unauthorised person becomes more difficult.

The VPIN Codes applicable for a particular day would be derived from the digits indicated by the column headings 32 and row labels 33 as exemplified below.

### EXAMPLE 1

### VPIN Codes as in FIG. 3

In this first example based upon the VPIN Code Card 20 of FIG. 3, the VPIN required is derived from the grid references for Month and Date as shown on the grid. For example, a VPIN for July 24th would be derived from:

JUL 489 being the 1st, 2nd & 3rd digits for the month

24th 248 i.e. the digits in row 2, column 4, the 1st, 2nd & 3rd digits for the date

From these numbers, and possibly including a Fixed PIN, the VPIN required could be any one of a number of alternatives, depending upon the regime provided for.

In an interactive system, the Master System 10 could prompt the required input, together with one or more Fixed PIN digits: thus

4 digit, no PIN-M3D2D1M2=Month 3rd, Date 2nd, Date 1st, Month 2nd=9428

6 digit, 4 digit PIN (taken as 1234)−D23P41M31=Date 2nd & 3rd,

Fixed PIN 4th & 1st, Month 3rd & 1st=484194

In a non interactive system, the user 12 has to be able to produce either a specific expected Code or one of a limited number of expected Codes, without any prompt from the system: thus, for 24th July as befores

4 digit VPIN any of 48, 89 or 94 from 489 any of 24, 48 or 82 from 248

giving nine different combinations in all

6 digit VPIN 489248 or 248489: only two unique numbers

### EXAMPLE 2

### VPIN Codes as in FIG. 4

FIG. 4 shows a VPIN Code Card 10 of FIG. 4 with a randomly generated series of both letters and digits 31 in a grid matrix identified by a column heading locator reference 41 above each character, being characters for weekdays, the date, the month and other factors (e.g. time of authentication is featured on the VPIN Code Card in FIG. 4 but not further illustrated). The VPIN Code Card 10 has a user or account number 21 which may again be set out in full or only in part for the reasons set out above.

In addition, for use if there is a secret PIN 14 (which is not recorded anywhere on the VPIN Code Card 10 and preferably not at all) associated with the VPIN, the PIN digits 42 are set out in threes under each day of the week, to indicate in a non interactive mode which PIN elements are required for use on a particular day and each occasion of use.

Thus for Friday 13th July, the elements indicated are:

| | | |
|---|---|---|
| for Friday | W | = 1c and PIN elements 354 (= 3rd, 5th & 4th) for first |
| | | use |
| for 13th | D | = 4x |
| for July | M | = 6z |

The VPIN constructed from these elements might be entirely digital, alphabetical or a mixture of both. Thus, in a digital telephone environment, only digital entry could be called for whereas on a personal computer or indeed verbally on a telephone, alphanumerical input would be possible. The actual construction of the required VPIN would depend upon the particular rules set out in a particular system for identifying required elements from the Code card 20, and the claimed invention is intended to cover all possible combinations.

n an interactive system, the Master System 10 would prompt the required input in randomly generated order together with one or more Fixed PIN digits: thus by way of illustration:

| | | |
|---|---|---|
| 3 digit, no PIN | M, D, W | = 641 |
| 3 character, no PIN | W, m, d | = 1zx |
| 5 digit with 5 digit Fixed PIN 12345 | W5MD2 | = 15642 |
| 5 character with 5 digit PIN | d, 2, w, 5, M | = x2c56 |

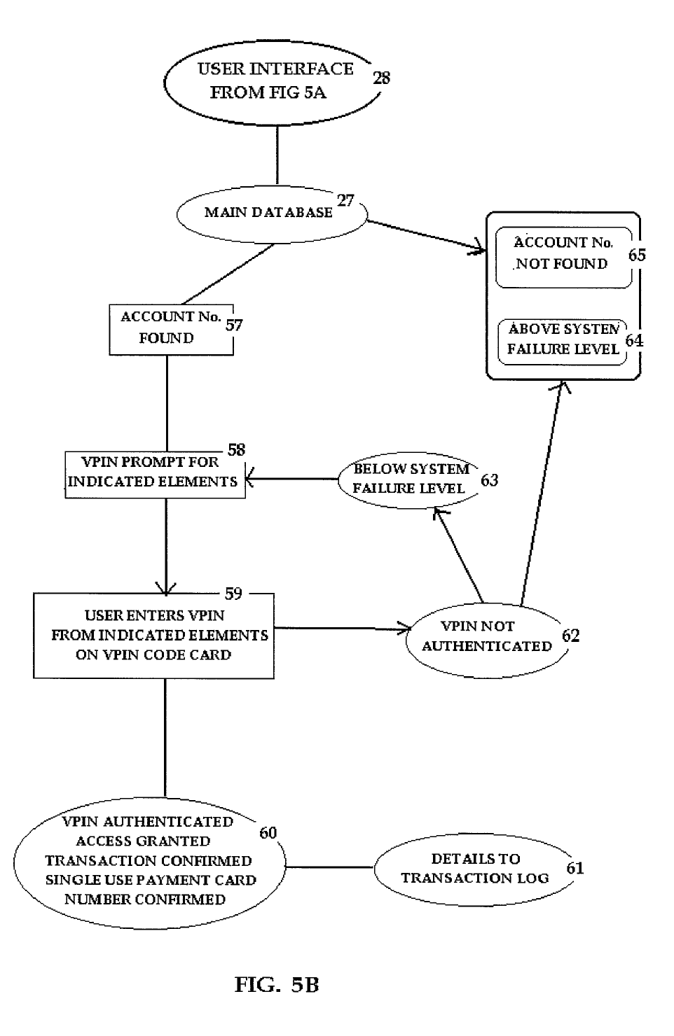

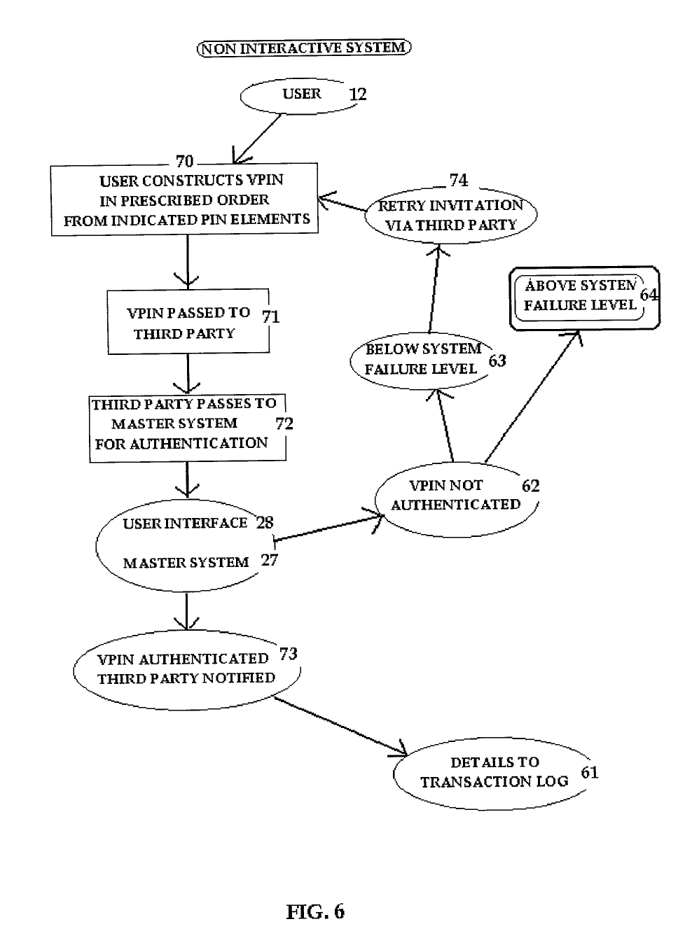

In an interactive system, described at FIG. 5, the elements from a fixed PIN 14 required would be as prompted, whereas for a non interactive system shown at FIG. 6 the VPIN may be constructed directly with the use of the PIN element prompt 23 for the day and occasion of use The order of the elements of the PIN element prompt 23 are randomly generated by the Master System 10 for each user 12 and associated VPIN Code Card 20.

By way of illustration, FIG. 4 shows a 6 digit VPIN based in fixed format on characters DP₂P₁MWP₃, where the PIN element here means the element indicated by the PIN element indicator 42 for the weekday: thus for Friday the 3 PIN elements are 3rd, 5th and 4th so that P2 means the second of the 3 PIN digits 42 which is the 5th actual digit of the PIN.

Thus the PIN element indicated in FIG. 4 is:

DP₂P₁MWP₃=Date, 2nd PIN element for the day/use, 1st PIN element for the day/use, Month, Weekday, 3rd PIN element for the day/use

Given a fixed PIN of 54321, again Friday 13th July and first use (so that PIN elements indicated 42 are 3rd, 5th & 4th), the VPIN would be:

Date=13th=4, 2nd PIN element=5th=PIN 1, 1st PIN element=3rd PIN 3, Month=6, Weekday=1, 3rd PIN element=4th=2 giving complete VPIN of 413612

Moreover in a non interactive fixed format mode, the reference to PIN digits 42 relates only to the first use of the day. To ensure variation, a second use on say Friday would involve the PIN digits 42 for Thursday i.e. 4th, 1st & 2nd, and for Wednesday for third use i.e. 3rd, 2nd & 5th and so on.

The system produces, from the fixed VPIN Code Card 10, a different VPIN on each occasion of use, whether from an interactive random prompt or from direct input in fixed format.

FIG. 5A shows a flowchart of the use of the VPIN for an interactive system 51, which may be for online access, a payment card system online or other interactive systems such as a networked computer system.

The user 12 connects with the User interface 28 online or by telephone link, and enters 52 in response to a request 55 his Account number 21. If a device 24 is employed in the VPIN system, then this may be inserted into a card reader 54 and itself input 56 the Account number 21.

FIG. 6 shows a flowchart of the steps subsequent to the user logging on to the User Interface 28.

Assuming the Account number 21 is found by the Master Database 27, details are copied to the User Interface 28 temporarily, and a random VPIN input prompt 58 is generated and sent to the user 12. This will prompt the system-set number of digits/letters making up the VPIN in random order, so that the required VPIN input would already be anticipated by the User Interface 28, albeit the VPIN being different on every occasion of use.

The user 12 would then enter the VPIN 59 from the required elements and the VPIN Code Card 20. If the VPIN 59 were correct, then the user 12 would as the case may be obtain system access, have a payment card transaction confirmed or have a confirmed single use payment card number confirmed, or otherwise be treated by the relevant Master System 10 as having been authenticated 60. At this stage, the User Interface 28 would send copy details to the Transaction Log 29.

If the VPIN 59 entered were incorrect 62, then depending upon the parameters set by the Master System 10 for failure tolerance, the user 12 would either be invited to try again 63 for an additional VPIN prompt 58, or having exceeded the system-set level would be refused 64, possibly resulting in a suspension of facilities.

FIG. 6 shows a flowchart of the use of the VPIN system by a user 12 in a non interactive environment. The user 12, based upon the date and the VPIN Code Card 20 would construct the appropriate VPIN 70 and enters/conveys this VPIN to a third party 71 who would in turn ultimately connect 72 with the User Interface 28 for verification 73 or rejection 62. On rejection 62, a further attempt may be allowed if below system failure level 63 but refused otherwise 64.

### Embodiments of the Invention

The preferred embodiments of the invention, in terms of VPIN construction as related to different applications, are described below.

Physical Payment Cards: the VPIN Codes and system could be used as customer identification instead of a signature or instead of a Fixed PIN, and could be input either into a hand held device linked to a Point of Sale machine, or directly into such machine. A four digit VPIN would be the maximum likely to gain customer acceptance and, because of the need for interoperability between various systems, it might be limited to countries where use of a Fixed PIN is customary now.

If use of a PIN were to become more widespread, as it may be with the introduction of the Smartcard, then a VPIN would obviously improve security and would assist in combating payment card fraud and card replication

Cash Cards: a four digit VPIN could replace the existing 4 digit Fixed PIN which is currently in use for all cash card transactions, and would greatly decrease the incidence of “cloning” new cards from overheard or intercepted card details gained in various ways including by fraudulent attachments to otherwise conventional Automated Teller Machines. ATM's are already on-line to the Issuing Bank, so that the attachment of a VPIN Code to each customer would be possible and would improve security.

Cardholder not present (CNP) transactions: the use of the VPIN for positive authentication would allow for a regime of unique once-only-use payment card numbers without the need for an actual card at all, for use in all CNP transactions, whether Internet, telephone or mail order. Such a unique payment card number would include the BIN (Bank identification number) and account number, plus the VPIN appropriate for the occasion together with a further last number calculated on each occasion of use to ensure that the whole payment card number adhered to any algorithm in use at the time (for example, the MOD10 algorithm currently in use).

The system would be available to registered customers, whose actual conventional payment card numbers or other debit authority would be on file and used to recoup the system operator for items purchased using the VPIN once-only card number system.

In an interactive system (which would be usually the case and certainly so for an Internet system) the authentication by input of the correct VPIN as prompted (as in Example 2) would result in the system notifying the customer (on-screen or otherwise) of a full unique once-only 16 digit payment card number for use on one occasion on that day (it would not, for example, work on the following day because of the changed VPIN element for Weekday and Date).

If an alphabetical input were prompted, the system would generate a specific unique number which although derived from the authenticated VPIN input need not have any similarity to it at all.

This system might be operated by a bank, with existing registered payment card details, or by a Trusted Third Party, who would register customers and issue VPIN Code Cards and operate as the Master System.

By using single use numbers that cannot be used again, the customers' fears concerning security on say the Internet might be drastically reduced.

Debit card remote usage: the system described would enable a debit card holder, presently reluctant to use their debit card number for remote transactions, to register for the system, thus using their debit card to actually pay for transactions whilst using a single use credit card number to order goods or services from the remote location.

The use of a VPIN for positive customer authentication would improve security for a range of other remote access systems including Remote Banking, Telephone charge cards, Merchant customer system for differentiated on-line usage, Club facility access, Remote computer access and Generic system access. The present invention provides for such a method in a manner which is intended to be as an adjunct to toher existing systems, and the exntent of the Claims is not to be restricted by the examples shown in detail.

### Summary and Advantages of the Invention

Thus the invention provides a method of remote authentication of registered users of controlled systems by providing for each registered user of the system to be required to produce an access code which varies for each user and for each occasion of use, by means of an account number, conventional fixed personal identification number and a random code grid matrix with embedded alphanumeric codes, in a preferred embodiment related to each weekday, date and month. The correct unique authentication code for any occasion for any registered user is known to a master computer system but may be produced by the registered user in a variety of ways, both online or in another interactive system and also directly from the code card without interactivity with the master system.

The codes are randomly generated and therefore cannot be predicted as no pattern exists. Moreover, the order in which elements of the codes are required to be input is also randomly generated, during the authentication process itself for an interactive system, and there is no requirement for encryption or any storage problems with correct access codes as each is generated on the occasion of use. Accordingly the computer power and memory required to operate the system is very small compared to other systems for similar purposes, and operating costs would accordingly be minimal.

I claim:

1. A method of authenticating a registered user of a system comprising the steps of:
registering users of a system by a system controller recording personal details and allocating an account number and Personal Identification Number
generating, by the system controller, for each registered user a different random plurality of alphanumeric access codes set out in an access code matrix form, having grid lines referenced by identifying characters whereby a code may be uniquely specified
communicating, by the system controller, to the registered user details of the account number, the Personal Identification Number and the access code matrix, together with specification of the criteria for identifying the appropriate access code on any given occasion
inputting, by the registered user, the account number plus a specific unique access code consisting of one or more characters from the access code matrix as determined by the criteria for that occasion
comparing, by the system controller, the access code input with that specified by the criteria
authenticating a registered user if the access code input corresponded with that specified by the criteria

2. The method of claim 1 wherein the access code matrix has grid lines comprising characters enabling the specification of a particular access code to be used on any given day in the year and wherein the criteria for the access code input includes the specification of a unique access code applicable on the day and on the occasion of input

3. The method of claim 2 wherein the criteria for the access code includes one or more digits from the Personal Identification Number

4. The method of claim 3 comprising the further steps of:
generating, by the system controller, a random order for the component parts of the access code for a registered user
communicating, by the system controller, such random order for the component parts of the access code to the registered user as part of the criteria for the input on any given occasion

5. The method of claim 3 wherein the component parts of the access codes for any given occasion are required to be entered in the random order generated by the system controller and communicated to the registered user during the input phase

6. A method of authenticating a registered user of a system comprising the steps of:
registering users of a system by a system controller recording personal details and allocating an account number and Personal Identification Number
generating, by the system controller, for each registered user a random plurality of alphanumeric access codes in a grid matrix form, having grid lines referenced by characters representing each weekday, each date and each month together with indicated elements of the Personal Identification Number for use on each occasion whereby the component parts of a code for any given date and occasion of use may be uniquely specified
generating, by the system controller, a random order for each of the component parts of the required access code
communicating, by the system controller, to the registered user details of the account number, the Personal Identification Number and the access code matrix, together with specification of the criteria for identifying the appropriate access code on any given occasion including the order in which component parts are to be input
inputting, by the registered user, the account number plus a specific unique access code in accordance with the criteria, and comprising components input in the specific order communicated to the registered user, comprising characters from the access code grid matrix and including one or more digits from the Personal Identification Number as referenced by the date of use, varying on each occasion if used more than once in one day
comparing, by the system controller, the unique access code input with that specified by the criteria and as derived from the access code matrix and the Personal Identification Number
authenticating a registered user if the access code input corresponded with that specified by the criteria

7. The method of claim 6 wherein the criteria specifies a four digit access code derived from digits referenced by the weekday, the date, the month and one from the Personal Identification Number

8. The method of claim 6 wherein the criteria specifies a five character access code derived from characters referenced by the weekday, the date, the month and two digits from the Personal Identification Number

9. The method of claim 6 wherein the criteria specifies a six character access code derived from characters referenced by the weekday, the date, the month and three digits from the Personal Identification Number

10. The method of claim 7 wherein the component parts of the access codes for any given occasion are required to be entered in the random order generated by the system controller and communicated to the registered user during the input phase

11. The method of claim 8 wherein the component parts of the access codes for any given occasion are required to be entered in the random order generated by the system controller and communicated to the registered user during the input phase

12. The method of claim 9 wherein the component parts of the access codes for any given occasion are required to be entered in the random order generated by the system controller and communicated to the registered user during the input phase

13. A method of integrating the authentication of a registered user of a payment card system with the allotment of proxy numbers for secure remote payment card transactions comprising:
registering users of a payment card system by a system controller recording personal details, allocating an account number and Personal Identification Number, and recording details of a payment card number or other account with an appropriate debit authority
generating, by the system controller, for each registered user a random plurality of alphanumeric access codes in a grid matrix form, having grid lines referenced by characters representing each weekday, each date and each month together with indicated elements of the Personal Identification Number whereby a code for any given date and occasion of use may be uniquely specified together with specification of the criteria for identifying the appropriate access code on any given occasion including the order in which component parts are to be input
communicating, by the system controller, to the registered user details of the account number, the Personal Identification Number and the access code matrix, together with specification of the criteria for identifying the appropriate access code on any given occasion including the order in which component parts are to be input
inputting, by the registered user, the account number plus a specific unique access code in accordance with the criteria, and comprising components input in the specific order communicated to the registered user, comprising characters from the access code grid matrix and including one or more digits from the Personal Identification Number as referenced by the date of use, varying on each occasion if used more than once in one day
comparing, by the system controller, the unique access code input with that specified by the criteria and as derived from the access codes and Personal Identification Number
authenticating a registered user if the access code input corresponded with that specified by the criteria, by allotting a unique 16 digit payment card number available for use on that day for one occasion only and including therein the system controller's Bank identification number, the account number, part at least of the access code and a checksum digit
charging the user by debit to an actual account for any sums used with that unique proxy number
